(19) United States
(12) Patent Application Publication
(10) Pub. No.: US 2025/0296136 A1
(43) Pub. Date: Sep. 25, 2025

(54) PORTABLE MACHINE TOOLS AND RELATED METHODS

(71) Applicant: Climax Portable Machine Tools, Inc., Newberg, OR (US)

(72) Inventors: Joshua Elwood FLATT, Tigard, OR (US); Scott Jeffery THIEL, Sherwood, OR (US); Andrew Gordon THOMPSON, Flat Rock, NC (US); Nolan Pieter VILJOEN, Beaverton, OR (US); Reuben David NESS, Milwaukie, OR (US)

(21) Appl. No.: 19/083,182

(22) Filed: Mar. 18, 2025

Related U.S. Application Data
(60) Provisional application No. 63/568,982, filed on Mar. 22, 2024.

(51) Int. Cl. B21D 39/02

(52) U.S. Cl. CPC B21D 39/025; B21D 39/023

(57) ABSTRACT

Portable machine tools for machining an annular flange comprise a frame, a tool head operatively supported by the frame and positioned to operatively machine the outer annular surface of the annular flange, and a plurality of rollers operatively supported by the frame and positioned to operatively engage and roll along one of the inward face or the outward face of the annular flange. The portable machine tool is configured to be operatively installed to rotate relative to the annular flange for machining the outer annular surface of the annular flange with the tool head. Methods of machining annular flanges also are disclosed.

### RELATED APPLICATION

This application claims priority to and incorporates by reference U.S. Provisional Patent Application No. 63/568,982, filed on Mar. 22, 2024, and entitled PORTABLE MACHINE TOOLS AND RELATED METHODS.

### FIELD

The present disclosure relates to portable machine tools.

### BACKGROUND

Flanges of tubular structures (e.g., wind turbine towers, pipes, large pipelines, etc.) need to be resurfaced occasionally to maintain the integrity of the connection between adjacent components. Flange facers and circular (or orbital) mills define a category of portable machine tools that are used to machine such flanges. However, the larger a tubular structure is, the larger the flange facer or circular mill must be. For very large tubular structures, the cost and weight of a typical flange facer or circular mill may be prohibitive.

### SUMMARY

Portable machine tools for machining an annular flange comprise a frame, a tool head operatively supported by the frame and positioned to operatively machine the outer annular surface of the annular flange, and a plurality of rollers operatively supported by the frame and positioned to operatively engage and roll along one of the inward face or the outward face of the annular flange. The portable machine tool is configured to be operatively installed to rotate relative to the annular flange for machining the outer annular surface of the annular flange with the tool head.

Methods of machining an annular flange comprise rotating a portable machine tool relative to the annular flange by rolling a plurality of rollers of the portable machine tool along one of the inward face or the outward face of the annular flange.

Methods of machining an annular flange comprise surveying the outer annular surface of the annular flange to detect a surface contour of the outer annular surface, and adjusting a position of a portable machine tool relative to the outer annular surface based at least in part on the surface contour detected by the surveying.

### BRIEF DESCRIPTION OF THE DRAWINGS

FIG. 1 is a schematic diagram representing portable machine tools according to the present disclosure.

FIG. 2 is a schematic fragmentary cross-sectional diagram representing a portion of portable machine tools according to the present disclosure in conjunction with an inward L-flange.

FIG. 3 is a schematic fragmentary cross-sectional diagram representing a portion of portable machine tools according to the present disclosure in conjunction with a T-flange.

FIG. 4 is a schematic fragmentary cross-sectional diagram representing a portion of portable machine tools according to the present disclosure in conjunction with an outward L-flange.

FIG. 5 is an isometric view of an example portable machine tool according to the present disclosure.

FIG. 6 is an opposite isometric view of the portable machine tool of FIG. 5.

FIG. 7 is a front view of the portable machine tool of FIG. 5.

FIG. 8 is a rear view of the portable machine tool of FIG. 5.

FIG. 9 is a bottom view of the portable machine tool of FIG. 5.

FIG. 10 is a top view of the portable machine tool of FIG. 5.

FIG. 11 is a left-side view of the portable machine tool of FIG. 5.

FIG. 12 is a right-side view of the portable machine tool of FIG. 5.

FIG. 13 is a flowchart schematically representing methods according to the present disclosure.

FIG. 14 is a flowchart schematically representing additional methods according to the present disclosure.

### DESCRIPTION

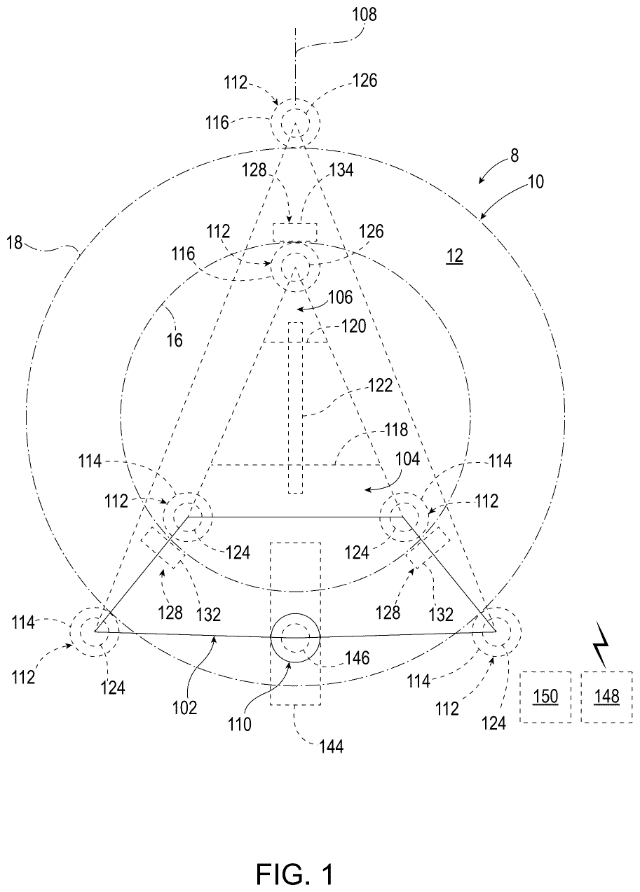

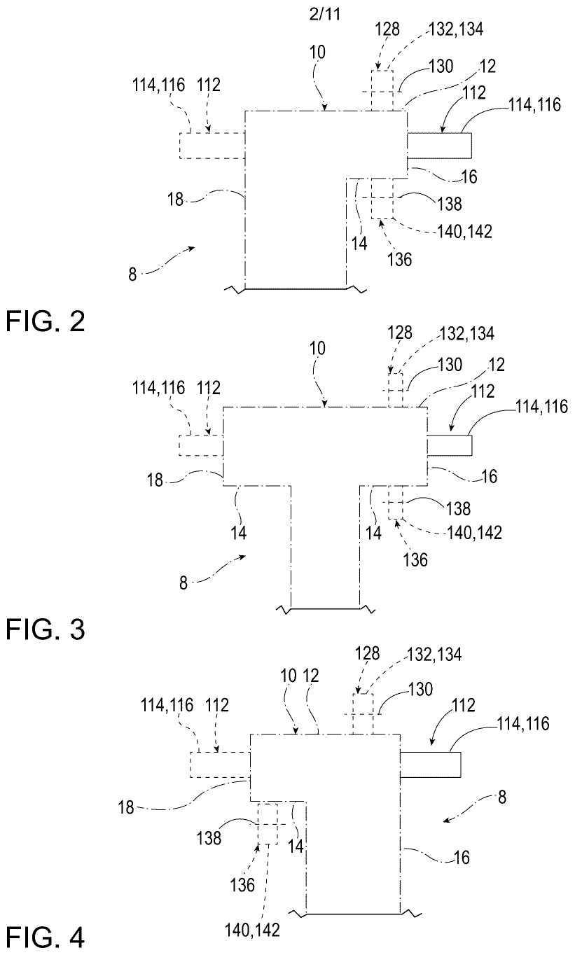

Portable machines tools 100 according to the present disclosure are schematically represented in FIGS. 1 and 2. Generally in the figures, elements that are likely to be included in a given example are illustrated in solid lines, while elements that are optional to a given example or that correspond to one or more specific examples are illustrated in broken lines. However, elements that are illustrated in solid lines are not essential to all examples of the present disclosure, and an element shown in solid lines may be omitted from a particular example without departing from the scope of the present disclosure.

Portable machine tools 100 additionally or alternatively may be described as flange facers and/or as circular mills, and may be configured specifically for machining annular flanges of very large tubular structures, such as having diameters in the 4-15 meter range. However, portable machine tools 100 also may be configured for machining tubular structures with diameters outside of this range, including diameters smaller than this range and diameters larger than this range. In FIGS. 1-4, portable machine tools 100 are schematically represented in connection with a tubular structure 8 in dash-dot lines. The tubular structure 8 comprises an annular flange 10 having an outer annular surface 12, an inner annular surface 14 that is opposite the outer annular surface 12, an inward face 16, and an outward face 18. Depending on the configuration of the tubular structure 8 and the annular flange 10 thereof, in some examples, the inward face 16 extends between the outer annular surface 12 and the inner annular surface 14, such as in connection with an inward L-flange or a T-flange, as represented in FIGS. 2 and 3. In other examples, such as in connection with an outward L-flange, the inward face 16 corresponds to the inside surface of the tubular structure 8.

As schematically represented in FIG. 1, portable machines tools 100 typically comprise at least a frame 102, a tool head 110, and a plurality of rollers 112. The tool head 110 is operatively supported by the frame 102 and is positioned to operatively machine the outer annular surface 12 of the annular flange 10 when the portable machine tool 100 is operatively mounted relative to the annular flange. In particular, the tool head 110 comprises or is configured to operatively receive a corresponding cutting tool for machining (resurfacing) the outer annular surface 12 of the annular flange 10.

In some examples, the frame 102 comprises a proximal region 104 and a distal region 106 that is opposite the proximal region 104 along a longitudinal axis 108 of the frame 102. In such example, the plurality of rollers 112 comprises proximal rollers 114 and a distal roller 116. The proximal rollers 114 are operatively supported by the proximal region 104 of the frame 102 and the distal roller 116 is operatively supported by the distal region 106 of the frame 102.

As schematically represented in FIG. 1, in some examples, the proximal rollers 114 and the distal roller 116 are positioned to operatively engage and roll along the inward face 16 of the annular flange 10 when the portable machine tool 100 is operatively mounted relative to the annular flange 10. In another example, as schematically represented in FIG. 1, the proximal rollers 114 and the distal roller 116 are positioned to operatively engage and roll along the outward face 18 of the annular flange 10 when the portable machine tool 100 is operatively mounted relative to the annular flange 10.

Accordingly, portable machine tools 100 may be described as being configured to be operatively installed to rotate relative to an annular flange 10 of a tubular structure 8 for machining the outer annular surface 12 of the annular flange 10 with the tool head 110.

In some examples, portable machine tools 100 are configured to be selectively adjusted to fit a range of diameters of tubular structures 8. As schematically represented in FIG. 1, in some examples, the frame 102 comprises a proximal portion 118 and a distal portion 120. In such examples, the proximal portion 118 comprises the proximal region 104, the distal portion 120 comprises the distal region 106, and the proximal portion 118 and the distal portion 120 are configured to be selectively adjusted relative to each other along the longitudinal axis 108 for operative engagement of the proximal rollers 114 and the distal roller 116 with one of the inward face 16 or the outward face 18 of the annular flange 10.

In some such examples and as schematically represented in FIG. 1, portable machine tools 100 further comprise an adjustment mechanism 122 that is operatively coupled to the proximal portion 118 and to the distal portion 120, and that is configured to selectively adjust the proximal portion 118 relative to the distal portion 120 along the longitudinal axis 108. As illustrative non-exclusive examples, the adjustment mechanism 122 may comprise one or more of a feed screw, a hydraulic cylinder, a track, a rail, a clamp, a motor, etc., that is/are configured to facilitate the selective translation of the proximal portion 118 relative to the distal portion 120.

As schematically represented in FIG. 1, some portable machine tools 100 further comprise one or more proximal roller motors 124 that are operatively supported by the frame 102, are operatively coupled to the proximal rollers 114, and are configured to selectively rotate the proximal rollers 114 for operative rotation of the portable machine tool 100 relative to the annular flange 10. In some such examples, an individual proximal roller motor 124 is associated with each of the proximal rollers 114; however, it also is within the scope of the present disclosure that a single proximal roller motor 124 may be operatively coupled to more than one proximal roller 114.

As also schematically represented in FIG. 1, some portable machine tools 100 further comprise a distal roller motor 126 that is operatively supported by the frame 102, that is operatively coupled to the distal roller 116, and that is configured to selectively rotate the distal roller 116 for operative rotation of the portable machine tool 100 relative to the annular flange 10.

As schematically represented in both FIGS. 1-4, some portable machine tools 100 further comprise outer rollers 128 that are operatively supported by the frame 102 and that are positioned to operatively engage and roll along the outer annular surface 12 of the annular flange 10 when the portable machine tool 100 operatively rotates relative to the annular flange 10. In some such examples, the outer rollers 128 have outer-roller rolling axes 130 and are configured to be selectively translated relative to the frame 102 generally along (e.g., along an axis that is within 10 degrees of) the outer-roller rolling axes 130 for engagement of a selected radial portion of the outer annular surface 12 of the annular flange 10. For example, once a first radial portion of the outer annular surface 12 has been resurfaced, the outer rollers 128 may be operatively positioned to engage the first radial portion of the outer annular surface 12, thereby ensuring a smooth rotation of the portable machine tool 100 relative to the outer annular surface 12.

In some examples, the outer rollers 128 additionally or alternatively are configured to be selectively translated relative to the frame 102 in a direction that is generally perpendicular to the outer-roller rolling axes 130, toward and away from the outer annular surface 12 of the annular flange 10. Accordingly, the position of the outer rollers 128 relative to the frame 102 may be selectively translated to position the tool head 110 in an appropriate position relative to the outer annular surface 12 for operative machining thereof. In some such examples, the outer rollers 128 are configured to be actively translated relative to the frame 102 in a direction that is generally perpendicular to the outer-roller rolling axes 130, toward and away from the outer annular surface 12 of the annular flange 10, based at least in part on a surface contour of the outer annular surface 12 of the annular flange 10. In other words, the position of the outer rollers 128 relative to the frame 102 may be actively adjusted to ensure that the frame 102, and thus the tool head 110, rotates within a single plane without wobbling, even if the initial surface contour of the outer annular surface 12 is not perfectly planar.

In some examples and as schematically represented in FIG. 1, the outer rollers 128 comprise proximal outer rollers 132 that are supported by the proximal region 104 of the frame 102 and a distal outer roller 134 that is supported by the distal region 106 of the frame 102. In some such examples, an outer roller 128 is associated with each of the proximal rollers 114 and the distal roller 116. That is, an outer roller 128 may be positioned in close proximity to a corresponding proximal roller 114 or distal roller 116, as schematically and optionally represented in FIG. 1.

As schematically represented in FIG. 2-4, some portable machine tools 100 further comprise inner rollers 136 that are operatively supported by the frame 102 and that are positioned to operatively engage and roll along the inner annular surface 14 of the annular flange 10 when the portable machine tool 100 operatively rotates relative to the annular flange 10. In some examples, the inner rollers 136 have inner-roller rolling axes 138 and are configured to be selectively translated relative to the frame 102 in a direction that is generally perpendicular to the inner-roller rolling axes 138, toward and away from the inner annular surface 14 of the annular flange 10. Accordingly, the position of the inner rollers 136 relative to the frame 102 may be selectively translated to position the tool head 110 in an appropriate position relative to the outer annular surface 12 for operative machining thereof.

In some examples, the inner rollers 136 comprise proximal inner rollers 140 that are supported by the proximal region 104 of the frame 102 and a distal inner roller 142 that is supported by the distal region 106 of the frame 102. In some such examples that also comprise outer rollers 128, an inner roller 136 is associated with each outer roller 128. That is, an inner roller 136 may be positioned generally opposite an outer roller 128 relative to the annular flange 10 when the portable machine tool 100 is operatively installed. In such examples, the pairs of opposing rollers may be described as a clamp for operatively clamping the portable machine tool 100 to the annular flange 10.

In some examples of portable machine tools 100, the tool head 110 is configured to be operatively translated relative to the frame 102 for machining a selected radial portion of the outer annular surface 12 of the annular flange 10. For example, as schematically represented in FIG. 1, portable machine tools 100 may further comprise a tool bridge 144 that is operatively supported by the frame 102 (e.g., by the optional proximal portion 118 of the frame 102), with the tool head 110 operatively coupled to the tool bridge 144 and configured to be selectively translated along the tool bridge 144. In some such examples, the tool bridge 144 is configured to be selectively translated relative to the frame 102 along the longitudinal axis 108.

With continued reference to FIG. 1, some portable machine tools 100 further comprise a tool motor 146 that is operatively coupled to the tool head 110 for rotation of a tool operatively supported by the tool head 110. Such a tool motor 146 may be a hydraulic motor, a pneumatic motor, or an electric motor.

As schematically represented in FIG. 1, some portable machines tools 100 further comprise a controller 148 that is configured to control one or more aspects of portable machine tools 100. For example, the controller 148 may be configured to control one or more of: (i) operation of the tool head 110, (ii) rotation of the proximal rollers 114, (iii) rotation of the distal roller 116, (iv) adjustment of the proximal portion 118 relative to the distal portion 120 of the frame 102, (v) the adjustment mechanism 122, (vi) the one or more proximal roller motors 124, (vii) the distal roller motor 126, (viii) adjustment of the outer rollers 128 generally along the outer-roller rolling axes 130, (ix) adjustment of the outer rollers 128 generally perpendicular to the outer-roller rolling axes 130, (x) active adjustment of the outer rollers 128 generally perpendicular to the outer-roller rolling axes 130, based at least in part on a surface contour of the outer annular surface 12 of the annular flange 10, (xi) adjustment of the inner rollers 136 generally perpendicular to the inner-roller rolling axes 138, (xii) position of the tool head 110 relative to the frame 102, (xiii) position of the tool head 110 relative to the tool bridge 144, (xiv) position of the tool bridge 144 relative to the frame 102, and (xv) operation of the tool motor 146.

The controller 148 may be any suitable device or devices that are configured to perform the functions of the controller 148 discussed herein. For example, the controller 148 may include one or more of an electronic controller, a dedicated controller, a special-purpose controller, a personal computer, a special-purpose computer, a display device, a logic device, a memory device, and/or a memory device having computer-readable media suitable for storing computer-executable instructions for implementing aspects of portable machine tools 100 and/or methods according to the present disclosure. In FIG. 1, the controller 148 is represented with a lightning bolt to schematically represent communication (e.g., wired and/or wireless) with other components of a portable machine tool 100.

As also schematically represented in FIG. 1, some portable machine tools 100 further comprise a surface surveyor 150 that is configured to detect the surface contour of the outer annular surface 12 of the annular flange 10. In such examples, the controller 148 is configured to actively adjust the outer rollers 128 generally perpendicular to the outer-roller rolling axes 130, based at least in part on the surface contour of the outer annular surface 12 of the annular flange 10 detected by the surface surveyor 150. The surface surveyor 150 may take a variety of suitable forms, including for example, a laser system, such as sold under the EASY-LASER™ brand.

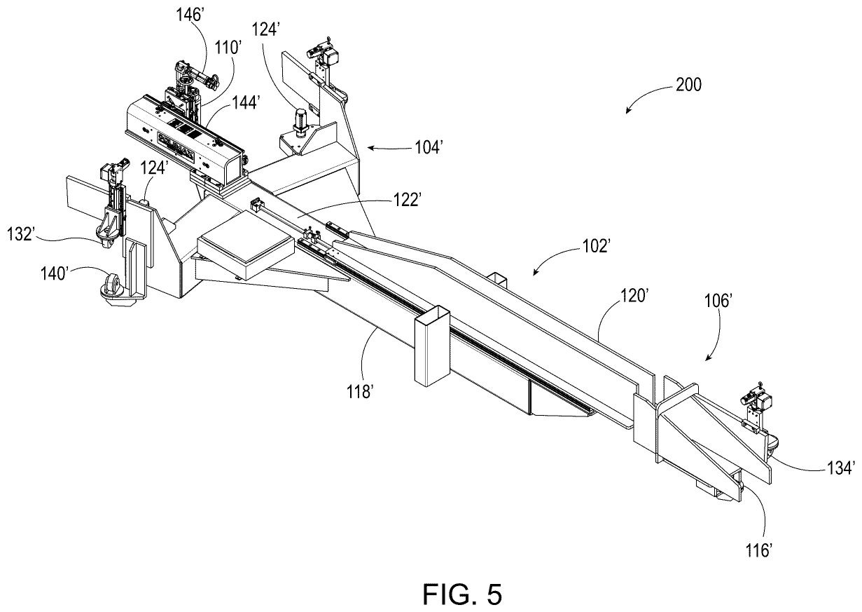

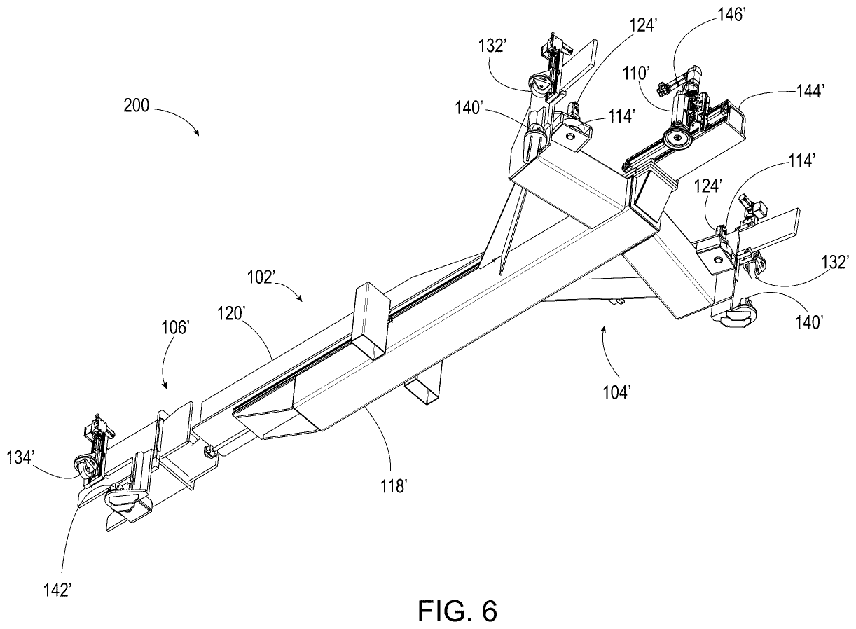

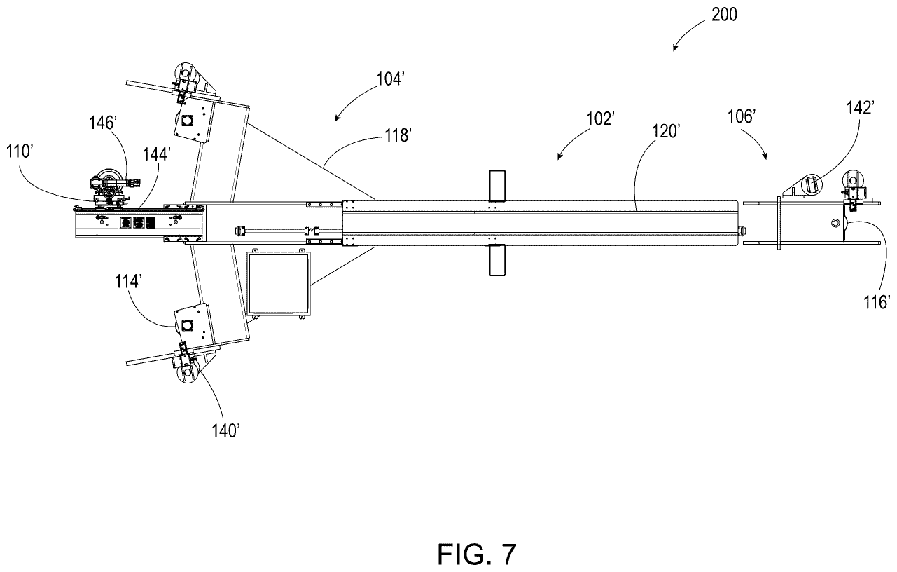

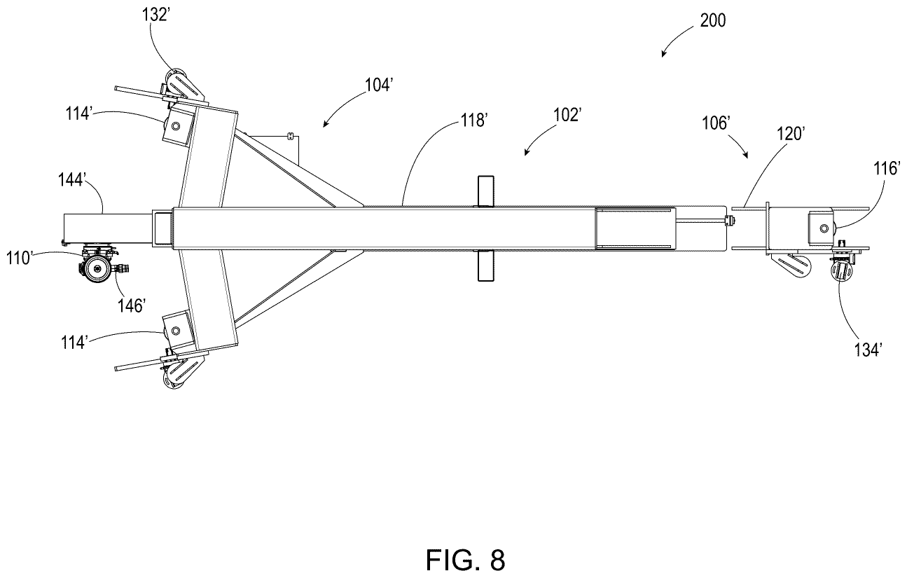

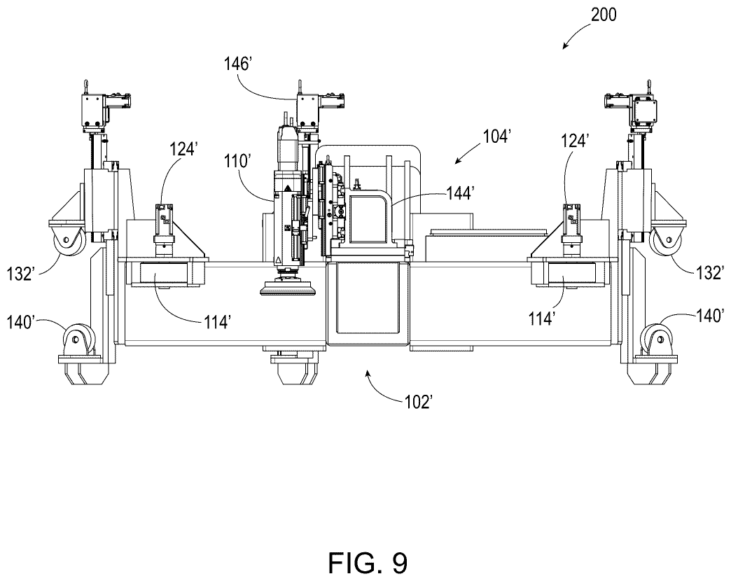

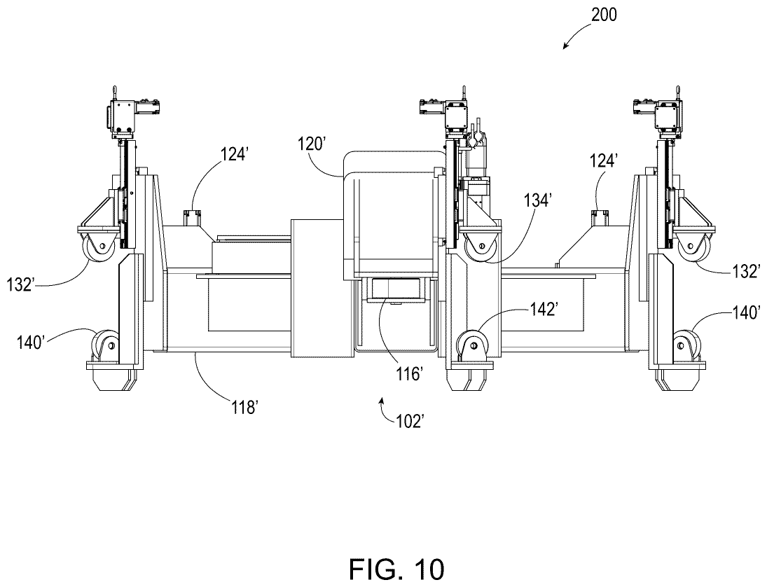

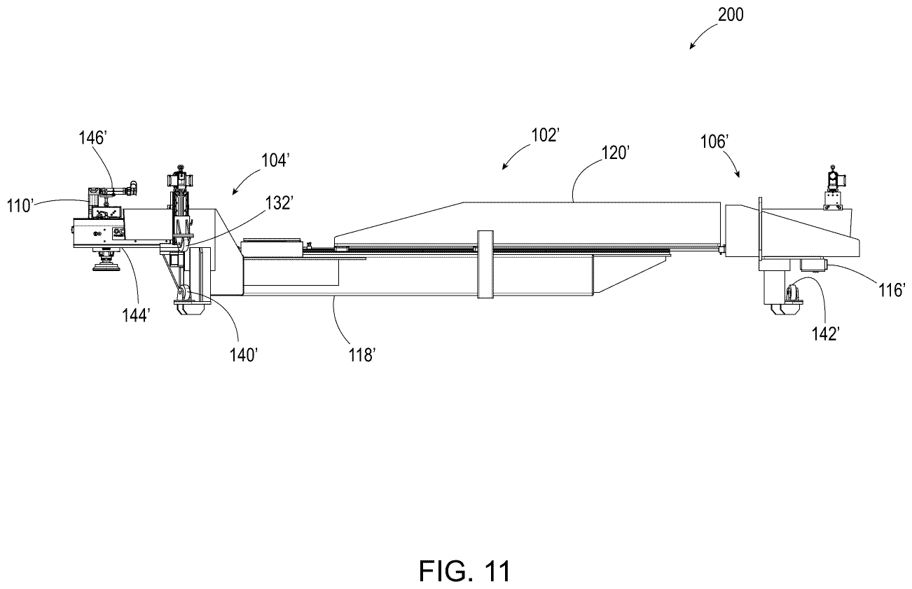

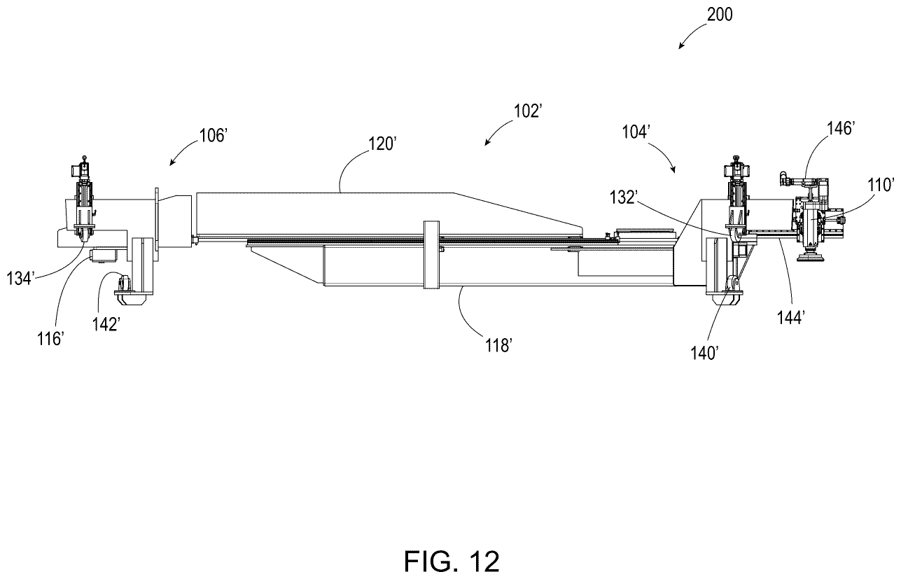

Turning now to FIGS. 5-12, an illustrative non-exclusive example of a portable machine tool 100 is illustrated in form of portable machine tool 200. Where appropriate, the reference numerals from the schematic illustration of FIG. 1-4 are used with a prime symbol (′) to designate corresponding parts of the illustrated example components; however, the example of FIGS. 5-12 are non-exclusive and do not limit portable machine tools 100 to the illustrated embodiment of FIGS. 5-12. That is, portable machine tools 100 are not limited to the specific embodiment of the illustrated portable machine tool 200, and portable machine tools 100 may incorporate any number of the various aspects, configurations, characteristics, properties, etc. of portable machine tools 100 that are illustrated in and discussed with reference to the schematic representations of FIGS. 1-4 and/or the embodiment of FIGS. 5-12, as well as variations thereof, without requiring the inclusion of all such aspects, configurations, characteristics, properties, etc. For the purpose of brevity, each previously discussed component, part, portion, aspect, region, etc. or variants thereof may not be discussed, illustrated, and/or labeled again with respect to portable machine tool 200. However, it is within the scope of the present disclosure that the previously discussed features, variants, etc. may be utilized with portable machine tool 200.

Portable machine tool 200 of FIGS. 5-12 is an example of a portable machine tool 100 whose frame 102′ comprises a proximal portion 118′ and a distal portion 120′, configured to be selectively translated relative to each other for operative engagement of the proximal rollers 114′ and a distal roller 116′ with an inward face of an annular flange. In particular, as best seen in FIG. 3, the portable machine tool 200 comprises an adjustment mechanism 122′ that comprises a lead screw.

Portable machine tool 200 also is an example of a portable machine tool 100 that comprises pairs of opposing rollers 132′, 140′; 134′, 142′ that serve as clamps for securing the portable machine tool 200 to an annular flange.

Portable machine tool 200 comprises proximal roller motors 124′ associated with each proximal roller 114′.

Portable machine tool 200 also comprises a tool bridge 144′ and a tool motor 146′ in the form of a hydraulic motor.

Proximal outer rollers 132′ of the portable machine tool 200 are configured to be selectively translated generally along the outer-roller rolling axes thereof and generally perpendicular thereto. Similarly, the distal outer roller 134′ is configured to be selectively translated generally along an inner-roller rolling axis thereof and generally perpendicular thereto.

Proximal inner rollers 140′ and the distal inner roller 142′, on the other hand, are fixed relative to the frame 102′.

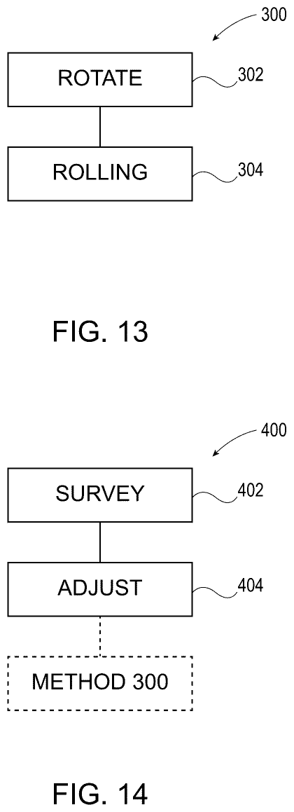

FIGS. 13 and 14 schematically provide flowcharts that represents illustrative, non-exclusive examples of methods according to the present disclosure. In FIG. 14, some steps are illustrated in dashed boxes, indicating that such steps may be optional or may correspond to an optional version of a method according to the present disclosure. That said, not all methods according to the present disclosure are required to include the steps that are illustrated in solid boxes. The methods and steps illustrated in FIGS. 13 and 14 are not limiting, and other methods and steps are within the scope of the present disclosure, including methods having greater than or fewer than the number of steps illustrated, as understood from the discussions herein.

With reference to FIG. 13, methods 300 comprise rotating 302 a portable machine tool relative to an annular flange by rolling 304 a plurality of rollers of the portable machine tool along one of an inward face or an outward face of the annular flange. In some methods 300, the portable machine tool is a portable machine tool 100 according to the present disclosure.

With reference to FIG. 14, methods 400 comprise surveying 402 an outer annular surface to detect a surface contour of the outer annular surface, and adjusting 404 a position of a portable machine tool relative to the outer annular surface based at least in part on the surface contour detected by the surveying 402. Some methods 400 further comprise a method 300 according to the present disclosure. In some methods 400, the portable machine tool is a portable machine tool 100 according to the present disclosure.

Illustrative, non-exclusive examples of inventive subject matter according to the present disclosure are described in the following enumerated paragraphs:

A. A portable machine tool (100) for machining an annular flange (10) that comprises an outer annular surface (12), an inner annular surface (14) opposite the outer annular surface (12), an inward face (16) extending between the outer annular surface (12) and the inner annular surface (14), and an outward face (18) opposite the inward face (16), wherein the portable machine tool (100) comprises:
a frame (102);
a tool head (110) operatively supported by the frame (102) and positioned to operatively machine the outer annular surface (12) of the annular flange (10); and
a plurality of rollers (112) operatively supported by the frame (102) and positioned to operatively engage and roll along one of the inward face (16) or the outward face (18) of the annular flange (10);
wherein the portable machine tool (100) is configured to be operatively installed to rotate relative to the annular flange (10) for machining the outer annular surface (12) of the annular flange (10) with the tool head (110).

A1. The portable machine tool (100) of paragraph A, wherein the frame (102) comprises a proximal region (104) and a distal region (106) opposite the proximal region (104) along a longitudinal axis (108) of the frame (102).

A1.1. The portable machine tool (100) of paragraph A1, wherein the plurality of rollers (112) comprises:
proximal rollers (114) operatively supported by the proximal region (104) of the frame (102); and
a distal roller (116) operatively supported by the distal region (106) of the frame (102).

A1.1.1. The portable machine tool (100) of paragraph A1.1, further comprising:
one or more proximal roller motors (124) operatively supported by the frame (102), operatively coupled to the proximal rollers (114), and configured to selectively rotate the proximal rollers (114) for operative rotation of the portable machine tool (100) relative to the annular flange (10).

A1.1.1.1. The portable machine tool (100) of paragraph A1.1.1, wherein the one or more proximal roller motors (124) comprises an individual proximal roller motor (124) associated with each of the proximal rollers (114).

A1.1.2. The portable machine tool (100) of any of paragraphs A1.1-A1.1.1.1, further comprising:
a distal roller motor (126) operatively supported by the frame (102), operatively coupled to the distal roller (116), and configured to selectively rotate the distal roller (116) for operative rotation of the portable machine tool (100) relative to the annular flange (10).

A1.1.3. The portable machine tool (100) of any of paragraphs A1.1-A1.1.2, wherein the proximal rollers (114) and the distal roller (116) are positioned to engage and roll along the inward face (16) of the annular flange (10).

A1.1.4. The portable machine tool (100) of any of paragraphs A1-A1.1.2, wherein the proximal rollers (114) and the distal roller (116) are positioned to engage and roll along the outward face (18) of the annular flange (10).

A1.1.5. The portable machine tool (100) of any of paragraphs A1.1-A1.1.4, wherein the frame (102) comprises a proximal portion (118) and a distal portion (120), wherein the proximal portion (118) comprises the proximal region (104), wherein the distal portion (120) comprises the distal region (106), and wherein the proximal portion (118) and the distal portion (120) are configured to be selectively adjusted relative to each other along the longitudinal axis (108) for operative engagement of the proximal rollers (114) and the distal roller (116) with one of the inward face (16) or the outward face (18) of the annular flange (10).

A1.1.5.1. The portable machine tool (100) of paragraph A1.1.5, further comprising:
an adjustment mechanism (122) operatively coupled to the proximal portion (118) and the distal portion (120) and configured to selectively adjust the proximal portion (118) relative to the distal portion (120) along the longitudinal axis (108).

A2. The portable machine tool (100) of any of paragraphs A-A1.1.5.1, further comprising:
outer rollers (128) operatively supported by the frame (102) and positioned to operatively engage and roll along the outer annular surface (12) of the annular flange (10) when the portable machine tool (100) operatively rotates relative to the annular flange (10).

A2.1. The portable machine tool (100) of paragraph A2, wherein the outer rollers (128) have outer-roller rolling axes (130) and are configured to be selectively translated relative to the frame (102) generally along the outer-roller rolling axes (130) for engagement of a selected radial portion of the outer annular surface (12) of the annular flange (10).

A2.2. The portable machine tool (100) of any of paragraphs A2-A2.1, wherein the outer rollers (128) have (the) outer-roller rolling axes (130) and are configured to be selectively translated relative to the frame (102) generally perpendicular to the outer-roller rolling axes (130), toward and away from the outer annular surface (12) of the annular flange (10).

A2.2.1. The portable machine tool (100) of paragraph A2.2, wherein the outer rollers (128) are configured to be actively translated relative to the frame (102) generally perpendicular to the outer-roller rolling axes (130), toward and away from the outer annular surface (12) of the annular flange (10) based at least in part on a surface contour of the outer annular surface (12) of the annular flange (10).

A2.3. The portable machine tool (100) of any of paragraphs A2-A2.2.1 when depending from paragraph A1, wherein the outer rollers (128) comprise proximal outer rollers (132) supported by the proximal region (104) of the frame (102), and a distal outer roller (134) supported by the distal region (106) of the frame (102).

A3. The portable machine tool (100) of any of paragraphs A-A2.3, further comprising:
inner rollers (136) operatively supported by the frame (102) and positioned to operatively engage and roll along the inner annular surface (14) of the annular flange (10) when the portable machine tool (100) operatively rotates relative to the annular flange (10).

A3.1. The portable machine tool (100) of paragraph A3, wherein the inner rollers (136) have inner-roller rolling axes (138) and are configured to be selectively translated relative to the frame (102) generally perpendicular to the inner-roller rolling axes (138), toward and away from the inner annular surface (14) of the annular flange (10).

A3.2. The portable machine tool (100) of any of paragraphs A3-A3.1 when depending from paragraph A1, wherein the inner rollers (136) comprise proximal inner rollers (140) supported by the proximal region (104) of the frame (102) and a distal inner roller (142) supported by the distal region (106) of the frame (102).

A4. The portable machine tool (100) of any of paragraphs A-A3.2, wherein the tool head (110) is configured to be operatively translated relative to the frame (102) for machining a selected radial portion of the outer annular surface (12) of the annular flange (10).

A4.1. The portable machine tool (100) of paragraph A4, further comprising:
a tool bridge (144) operatively supported by the frame (102), wherein the tool head (110) is operatively coupled to the tool bridge (144) and configured to be selectively translated along the tool bridge (144).

A4.1.1. The portable machine tool (100) of paragraph A4.1 when depending from paragraph A1, wherein the tool bridge (144) is configured to be selectively translated relative to the frame (102) along the longitudinal axis (108).

A5. The portable machine tool (100) of any of paragraphs A-A4.1.1, further comprising:
a tool motor (146) operatively coupled to the tool head (110) for rotation of a cutting tool operatively supported by the tool head (110).

A6. The portable machine tool (100) of any of paragraphs A-A5, further comprising a controller (148) configured to control one or more of:
operation of the tool head (110);
when depending from A1.1, rotation of the proximal rollers (114);
when depending from A1.1, rotation of the distal roller (116);
when depending from paragraph A1.1.5, adjustment of the proximal portion (118) relative to the distal portion (120) of the frame (102);
when depending from paragraph A1.1.5.1, the adjustment mechanism (122);
when depending from paragraph A1.1.1, the one or more proximal roller motors (124);
when depending from paragraph A1.1.2, the distal roller motor (126);
when depending from paragraph A2.1, adjustment of the outer rollers (128) generally along the outer-roller rolling axes (130);
when depending from paragraph A2.2, adjustment of the outer rollers (128) generally perpendicular to the outer-roller rolling axes (130);
when depending from paragraph A2.2.1, active adjustment of the outer rollers (128) generally perpendicular to the outer-roller rolling axes (130) based at least in part on the surface contour of the outer annular surface (12) of the annular flange (10);
when depending from paragraph A3.1, adjustment of the inner rollers (136) generally perpendicular to the inner-roller rolling axes (138);
when depending from paragraph A4, position of the tool head (110) relative to the frame (102);
when depending from paragraph A4.1, position of the tool head (110) relative to the tool bridge (144);
when depending from paragraph A4.1.1, position of the tool bridge (144) relative to the frame (102); and
when depending from paragraph A5, operation of the tool motor (146).

A6.1. The portable machine tool (100) of paragraph A6 when depending from paragraph A2.2.1, further comprising:
a surface surveyor (150) configured to detect a/the surface contour of the outer annular surface (12) of the annular flange (10); and
wherein the controller (148) is configured to actively adjust the outer rollers (128) generally perpendicular to the outer-roller rolling axes (130) based at least in part on the surface contour of the outer annular surface (12) of the annular flange (10) detected by the surface surveyor (150).

B. A method (300) of machining an annular flange that comprises an outer annular surface, an inner annular surface opposite the outer annular surface, an inward face extending between the outer annular surface and the inner annular surface, and an outward face opposite the inward face, comprising:
rotating (302) a portable machine tool relative to the annular flange by rolling (304) a plurality of rollers of the portable machine tool along one of the inward face or the outward face of the annular flange.

B1. The method (300) of paragraph B, wherein the portable machine tool is the portable machine tool (100) of any of paragraphs A-A6.1.

C. A method (400) of machining an annular flange that comprises an outer annular surface, an inner annular surface opposite the outer annular surface, an inward face extending between the outer annular surface and the inner annular surface, and an outward face opposite the inward face, comprising:
surveying (402) the outer annular surface to detect a surface contour of the outer annular surface; and
adjusting (404) a position of a portable machine tool (100) relative to the outer annular surface based at least in part on the surface contour detected by the surveying (402).

C1. The method (400) of paragraph C, further comprising the method (300) of paragraph B.

C2. The method (400) of any of paragraphs C-C1, wherein the portable machine tool is the portable machine tool (100) of any of paragraphs A-A6.1.

As used herein, the terms “adapted” and “configured” mean that the element, component, or other subject matter is designed and/or intended to perform a given function. Thus, the use of the terms “adapted” and “configured” should not be construed to mean that a given element, component, or other subject matter is simply “capable of” performing a given function but that the element, component, and/or other subject matter is specifically selected, created, implemented, utilized, programmed, and/or designed for the purpose of performing the function. It is also within the scope of the present disclosure that elements, components, and/or other recited subject matter that is recited as being adapted to perform a particular function may additionally or alternatively be described as being configured to perform that function, and vice versa. Similarly, subject matter that is recited as being configured to perform a particular function may additionally or alternatively be described as being operative to perform that function.

As used herein, the term “and/or” placed between a first entity and a second entity means one of (1) the first entity, (2) the second entity, and (3) the first entity and the second entity. Multiple entries listed with “and/or” should be construed in the same manner, i.e., “one or more” of the entities so conjoined. Other entities optionally may be present other than the entities specifically identified by the “and/or” clause, whether related or unrelated to those entities specifically identified. Thus, as a non-limiting example, a reference to “A and/or B,” when used in conjunction with open-ended language such as “comprising,” may refer, in one example, to A only (optionally including entities other than B); in another example, to B only (optionally including entities other than A); in yet another example, to both A and B (optionally including other entities). These entities may refer to elements, actions, structures, steps, operations, values, and the like.

The various disclosed elements of apparatuses and steps of methods disclosed herein are not required to all apparatuses and methods according to the present disclosure, and the present disclosure includes all novel and non-obvious combinations and subcombinations of the various elements and steps disclosed herein. Moreover, one or more of the various elements and steps disclosed herein may define independent inventive subject matter that is separate and apart from the whole of a disclosed apparatus or method. Accordingly, such inventive subject matter is not required to be associated with the specific apparatuses and methods that are expressly disclosed herein, and such inventive subject matter may find utility in apparatuses and/or methods that are not expressly disclosed herein.

1. A portable machine tool (100) for machining an annular flange (10) that comprises an outer annular surface (12), an inner annular surface (14) opposite the outer annular surface (12), an inward face (16) extending between the outer annular surface (12) and the inner annular surface (14), and an outward face (18) opposite the inward face (16), wherein the portable machine tool (100) comprises:
a frame (102);
a tool head (110) operatively supported by the frame (102) and positioned to operatively machine the outer annular surface (12) of the annular flange (10); and
a plurality of rollers (112) operatively supported by the frame (102) and positioned to operatively engage and roll along one of the inward face (16) or the outward face (18) of the annular flange (10);
wherein the portable machine tool (100) is configured to be operatively installed to rotate relative to the annular flange (10) for machining the outer annular surface (12) of the annular flange (10) with the tool head (110).

2. The portable machine tool (100) of claim 1, wherein the frame (102) comprises:
a proximal region (104); and
a distal region (106) opposite the proximal region (104) along a longitudinal axis (108) of the frame (102).

3. The portable machine tool (100) of claim 2, wherein the plurality of rollers (112) comprises:
proximal rollers (114) operatively supported by the proximal region (104) of the frame (102); and
a distal roller (116) operatively supported by the distal region (106) of the frame (102).

4. The portable machine tool (100) of claim 3, wherein the proximal rollers (114) and the distal roller (116) are positioned to engage and roll along the inward face (16) of the annular flange (10).

5. The portable machine tool (100) of claim 3, wherein the proximal rollers (114) and the distal roller (116) are positioned to engage and roll along the outward face (18) of the annular flange (10).

6. The portable machine tool (100) of claim 3, wherein the frame (102) comprises:
a proximal portion (118), comprising the proximal region (104); and
a distal portion (120), comprising the distal region (106);
wherein the proximal portion (118) and the distal portion (120) are configured to be selectively adjusted relative to each other along the longitudinal axis (108) for operative engagement of the proximal rollers (114) and the distal roller (116) with one of the inward face (16) or the outward face (18) of the annular flange (10).

7. The portable machine tool (100) of claim 6, further comprising:
an adjustment mechanism (122) operatively coupled to the proximal portion (118) and the distal portion (120) and configured to selectively adjust the proximal portion (118) relative to the distal portion (120) along the longitudinal axis (108).

8. The portable machine tool (100) of claim 2, further comprising:
outer rollers (128) operatively supported by the frame (102) and positioned to operatively engage and roll along the outer annular surface (12) of the annular flange (10) when the portable machine tool (100) operatively rotates relative to the annular flange (10).

9. The portable machine tool (100) of claim 8, wherein the outer rollers (128) have outer-roller rolling axes (130) and are configured to be selectively translated relative to the frame (102) generally perpendicular to the outer-roller rolling axes (130), toward and away from the outer annular surface (12) of the annular flange (10).

10. The portable machine tool (100) of claim 9, further comprising:
a surface surveyor (150) configured to detect a surface contour of the outer annular surface (12) of the annular flange (10).

11. The portable machine tool (100) of claim 10, further comprising:
a controller (148) configured to actively adjust the outer rollers (128) generally perpendicular to the outer-roller rolling axes (130) based at least in part on the surface contour of the outer annular surface (12) of the annular flange (10) detected by the surface surveyor (150).

12. The portable machine tool (100) of claim 8, wherein the outer rollers (128) comprise:
proximal outer rollers (132) supported by the proximal region (104) of the frame (102); and
a distal outer roller (134) supported by the distal region (106) of the frame (102).

13. The portable machine tool (100) of claim 2, further comprising:
inner rollers (136) operatively supported by the frame (102) and positioned to operatively engage and roll along the inner annular surface (14) of the annular flange (10) when the portable machine tool (100) operatively rotates relative to the annular flange (10).

14. The portable machine tool (100) of claim 13, wherein the inner rollers (136) have inner-roller rolling axes (138) and are configured to be selectively translated relative to the frame (102) generally perpendicular to the inner-roller rolling axes (138), toward and away from the inner annular surface (14) of the annular flange (10).

15. The portable machine tool (100) of claim 13, wherein the inner rollers (136) comprise:
proximal inner rollers (140) supported by a proximal region (104) of the frame (102); and
a distal inner roller (142) supported by a distal region (106) of the frame (102).

16. The portable machine tool (100) of claim 2, wherein the tool head (110) is configured to be operatively translated relative to the frame (102) for machining a selected radial portion of the outer annular surface (12) of the annular flange (10).

17. The portable machine tool (100) of claim 16, further comprising:
a tool bridge (144) operatively supported by the frame (102), wherein the tool head (110) is operatively coupled to the tool bridge (144) and configured to be selectively translated along the tool bridge (144).

18. The portable machine tool (100) of claim 17, wherein the tool bridge (144) is configured to be selectively translated relative to the frame (102) along the longitudinal axis (108).

19. A method (300) of machining an annular flange that comprises an outer annular surface, an inner annular surface opposite the outer annular surface, an inward face extending between the outer annular surface and the inner annular surface, and an outward face opposite the inward face comprising:
rotating (302) a portable machine tool relative to the annular flange by rolling (304) a plurality of rollers of the portable machine tool along one of the inward face or the outward face of the annular flange.

20. A method (400) of machining an annular flange that comprises an outer annular surface, an inner annular surface opposite the outer annular surface, an inward face extending between the outer annular surface and the inner annular surface, and an outward face opposite the inward face comprising:
surveying (402) the outer annular surface to detect a surface contour of the outer annular surface; and
adjusting (404) a position of a portable machine tool relative to the outer annular surface based at least in part on the surface contour detected by the surveying (402).
